(19) United States
(12) Patent Application Publication
(10) Pub. No.: US 2016/0300239 A1
(43) Pub. Date: Oct. 13, 2016

(54) System and method for managing and handling permits

(71) Applicant: Manuel Guerra-Mondragon, Guaynabo, PR (US)

(72) Inventor: Manuel Guerra-Mondragon, Guaynabo, PR (US)

(21) Appl. No.: 14/884,731

(22) Filed: Oct. 15, 2015

Related U.S. Application Data
(63) Continuation-in-part of application No. 14/680,818, filed on Apr. 7, 2015, now abandoned.

(51) Int. Cl. G06Q 30/00; G06Q 10/06

(52) U.S. Cl. CPC G06Q 30/018; G06Q 10/06311

(57) ABSTRACT

A method for managing and handling permits comprising the steps of accessing a computer platform in order to apply and/or renew services. The process significantly reduces the time of application for services by customers, tracking of the status of client's requests and payments. The computer platform comprises configured with a trust service module for verifying which client, inspector or authority agency are in compliance,

### STATEMENT REGARDING FEDERALLY SPONSORED RESEARCH AND DEVELOPMENT

N/A

### RELATED APPLICATIONS

This application claims the benefit of priority of U.S. no-provisional application Ser. No. 14/680,818, filed on Apr. 7, 2015.

### BACKGROUND OF THE DISCLOSURE

1. Technical Field

The present disclosure is directed a computer base platform that assists with the managing and handling of permits. More particularly, the invention relates to such systems with means for issuing permits and managing information about authority agency permits and/or renewals of several authority agencies permits.

2. Discussion of the Background

Currently several government agencies, such as the Department of Health holds applications and completes several inspection services manually. The process is inefficient, take too long to complete and the lack of a suitable control of applications.

The present disclosure is directed to overcoming the one or more problems or disadvantages associated with the prior art.

### SUMMARY OF THE DISCLOSURE

In accordance with one aspect of the present disclosure is to provide a computer base platform in order to manage the granting of several permits from a permitting agency, such as Health License, faster and more efficient.

Further another object of the present invention is to provide a computer base platform for the renewal of services in a hierarchy structure from a permitting agency. In accordance with the principles of the present disclosure a first exemplary embodiment provides accesses to people and companies access through an internet-based interactive computer base platform in order to apply and renew services. The process significantly reduces the time of application for services by customers, tracking of the status of client's requests and payments.

Another aspect of the present disclosure is to provide control of requests for services through a computer base platform, provide internal communication with customers via a notification medium such as email or text. Further the computer platform provides accounting of revenues from the sale of services and access to reports summarizing requests and action/status of said requests over a period of time.

Yet, another object of the present disclosure is to provide access to real time information, increase efficiency due to a quick process of application services, better customer service, provide a complete database of customers which can be used to provide new services (Email Marketing) Control, tracking of all transactions in the system and provide customer reports to users.

The present disclosure is directed to overcoming the one or more problems or disadvantages associated with the prior art.

As used herein, a “permitting agency” refers to an entity which is part of the hierarchy structure, typically governmental agency that has jurisdictional authority to approve or deny a permit relating specific matter, such as health. As used herein, “users” may refer to entity, person or company with access to the internet-based interactive computer base platform. Preferably, the internet-based interactive computer base platform comprises a database, a processor and at least a set of modules used to determine and identify the appropriate permitting agency where the applicable permits can be obtained.

### BRIEF DESCRIPTION OF THE DRAWINGS

The accompanying drawings, which are incorporated herein, constitute part of the specifications and illustrate the preferred embodiment of the disclosure.

FIG. 1 is a general illustration in accordance with the principles of the present disclosure.

FIG. 2 is a general illustration of the interaction of different modules with the computer base platform in accordance with the principles of the present disclosure.

FIG. 3 is a general illustration of an exemplary method for users to access the computer base platform in accordance with the principles of the present disclosure.

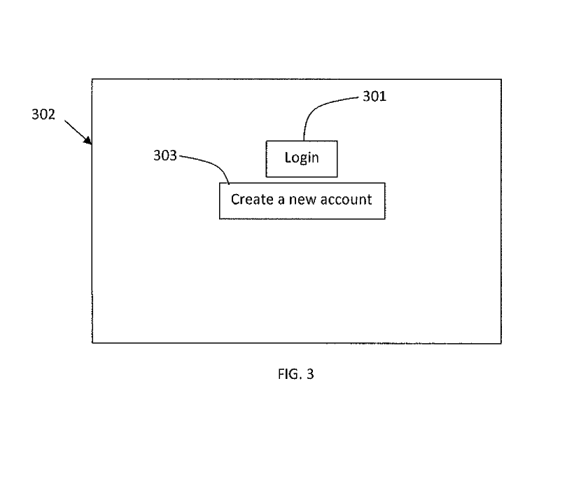

FIG. 4 is a block illustration of an exemplary method of operating the system for companies using the internet-based interactive computer base platform.

FIG. 5 is a block illustration of an exemplary method of operating the system for the manager using the internet-based interactive computer base platform.

FIG. 6 is a block illustration of an exemplary method of operating the system for the supervisor using the internet-based interactive computer base platform.

FIG. 7 is a block illustration of an exemplary method of operating the system for the finance supervisor using the internet-based interactive computer base platform.

FIG. 8 is a block illustration of an exemplary method of operating the system for users using the internet-based interactive computer base platform.

FIG. 9 is a block illustration of an exemplary method of operating the system for permitting agency using the internet-based interactive computer base platform.

FIG. 10 is a block illustration of an exemplary method of operating the system for inspector using the internet-based interactive computer base platform.

FIG. 11 is a block illustration of an exemplary method of operating the system for companies using the internet-based interactive computer base platform.

### DETAILED DESCRIPTION

The embodiments of the invention, more particularly the internet-based interactive computer base platform disclosed herein may be implemented, through the use of general-programming languages (such as C or C++). The program code can be disposed in any known computer-readable medium including semiconductor, magnetic disk, or optical disk (such as CD-ROM, DVD-ROM). As such, the code can be transmitted over communication networks including the Internet.

In the present disclosure, the terms “computer program medium” and “computer-usable medium” are used to generally refer to media such as a removable storage unit or a hard disk drive. Computer program medium and computer-usable medium can also refer to memories, such as system memory and graphics memory which can be memory semiconductors (e.g., DRAMs, etc.). These products are examples of how to provide software to a computer system.

The embodiments are also directed to computer products comprising software stored on any computer-usable medium. Such software, when executed in one or more data processing devices, causes a data processing device(s) to operate as described herein or, allows for the synthesis and/or manufacture of computing devices (e.g., ASICs, or processors) to perform embodiments described herein, Embodiments employ any computer-usable or -readable medium, and any computer-usable or -readable storage medium known now or in the future. Examples of computer-usable or computer-readable mediums may include, but are not limited to, primary storage devices (e.g., any type of random access memory or read-only memory), secondary storage devices (e.g., hard drives, floppy disks, CD ROMS, ZIP disks, tapes, magnetic storage devices, optical storage devices, MEMS, nanotechnological storage devices, etc.), and communication mediums (e.g., wired and wireless communications networks, local area networks, wide area networks, intranets, etc.).

For purposes of this discussion, the term “module” may include at least one of software, firmware, and hardware (such as one or more circuits, microchips, or devices, or any combination thereof), and any combination thereof. In addition, it will be understood that each module may include one or more components within an actual device, and each component that forms a part of the described module can function either cooperatively or independently of any other component forming a part of the module. Conversely, multiple modules described herein may represent a single component within an actual device. Further, components within a module may be in a single device or distributed among multiple devices in a wired or wireless manner.

Permits are used to authorize specific actions, as detailed in each permit. The permits are authorize by the authority agency, however inspector are certificated by said authority agencies to indicates if a user, more particular a client, is in compliance with the requirements stated by said authority agency. In

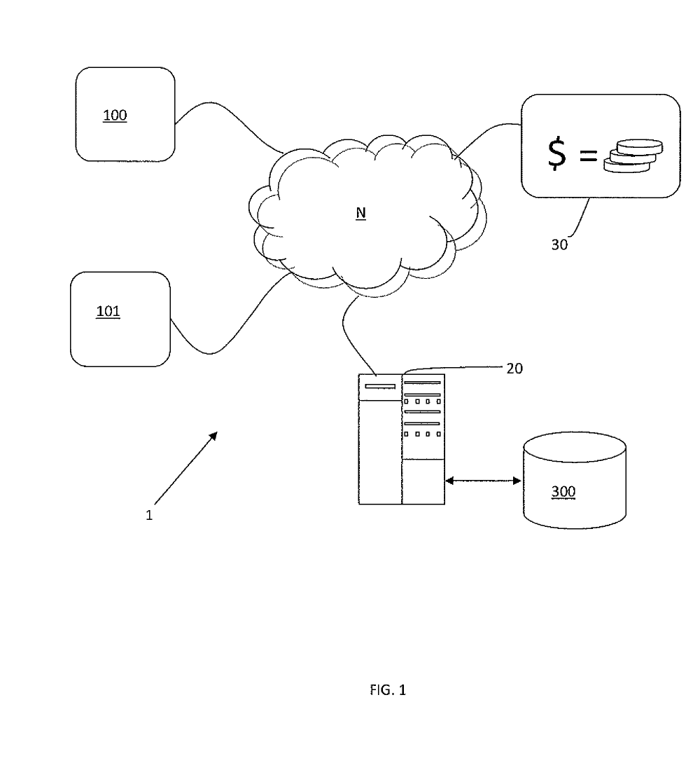

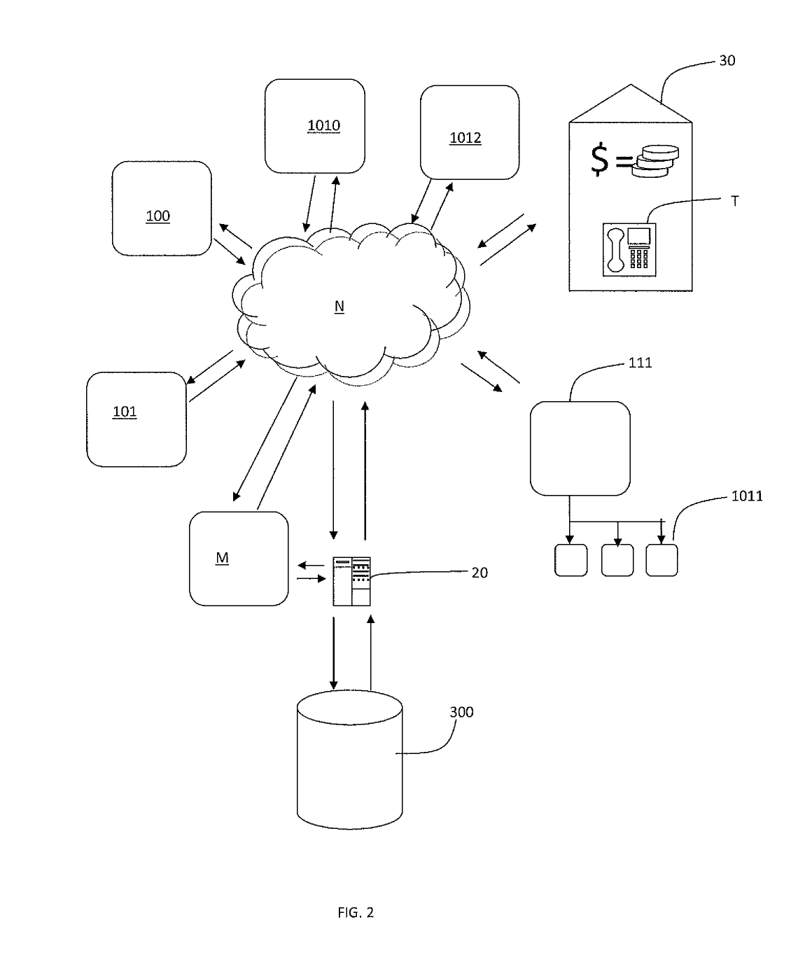

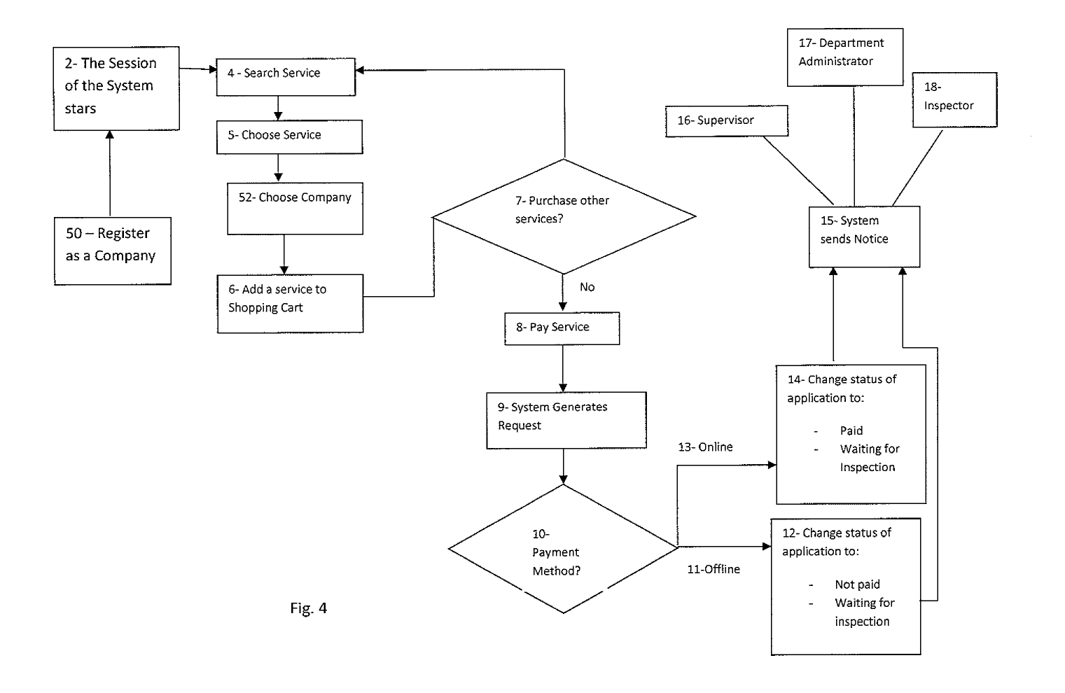

The present disclosure provides several modules directed to managing and handling information provided by users for achieving the completion of permits is a faster and efficient manner, The modules are described below. FIG. 1 is directed to the general structure of the system for managing permits 1. The computer platform 20 comprising at least a processor is coupled to a database 300. The computer platform 20 is accesses through a communication medium N by an user. As shown in FIG. 1, mainly the computer platform 20 is accessed by a user, such as a client 100 or an agency 101, and a finance supervisor module 30. However the user is not limit to those three, for example as shown in FIG. 2, the user may be a client 100, a supervisor 111, an inspector 1010, a client's representative 1112, a general manager M and an permit agency 101 may act as a user at any time. In order to access the computer base platform 20, as shown in FIG. 4, any user needs to register in order to acquire an unique authentication through an email and password. The unique authentication is directly related to the users' privileges, functions and authority through the computer platform 20. Subsequently the main privileges and functions of the user profiles are described in the computer base platform.

The computer base platform 20 comprises at least eight 8 user modules. Each module comprises at least a set of instructions to limit user access and manage of information at the computer platform 20. In other words each module authorizes any specific user, depending on the module, to performance specific activities.

The computer platform 20 is configured with a trust service module located inside the platform. The computer platform 20 receives requirements user and verify through the trust service module if the request is legit and if the action to acquire information regarding stored information is performed by the correspondent authority agency. The requirements include qualifications and certifications from said agencies. The computer platform 20 matches qualifications and user certifications in order to continue with the user request.

The computer platform 20 comprises several process to verify is an inspector or supervisor is in compliance with the current certifications. Further the computer platform 20 verifies if an inspector is in compliance to complete a task requested by a client. For example, permits may be used to conditionally allow entry to restricted areas or the, using encrypted digital messages.

Each module is equipped with regulation base on general manager requirements to complete or provide user privileges such as functions and computer platform hierarchy authority. The user modules are as follow:
General Managers module: The modules requires several certifications. The present module has access to all modules of the system, and carries out tasks of populating the database, mainly users, services and system parameters.
Department Administrators module: Administrator module have access to supervisor modules, inspector modules, clients modules and manager module of the system and carry out tasks of populating the database, mostly of users, applications and services for the department it belongs,
Supervisors module: Responsible of performing certain reports during different periods, assign inspectors to requests from clients seeking services and control operations in the process of purchasing services department.
Supervisors Finance module: Responsible for sales reports realize during a determine periods and controlling payments of customer service requests
Inspectors module: Examine through inspection services requested by customers, control applications they are in charge of and customer communication in case of any problem.
Customers module: They are individuals or companies that need to apply or renew different types of services.
Managers module: Are people who manage the application and renewal services a client (individual or company)
Agencies module: External entities that can access the documents of a client for the purposes they deem appropriate, subject to approval by the client with anticipation.

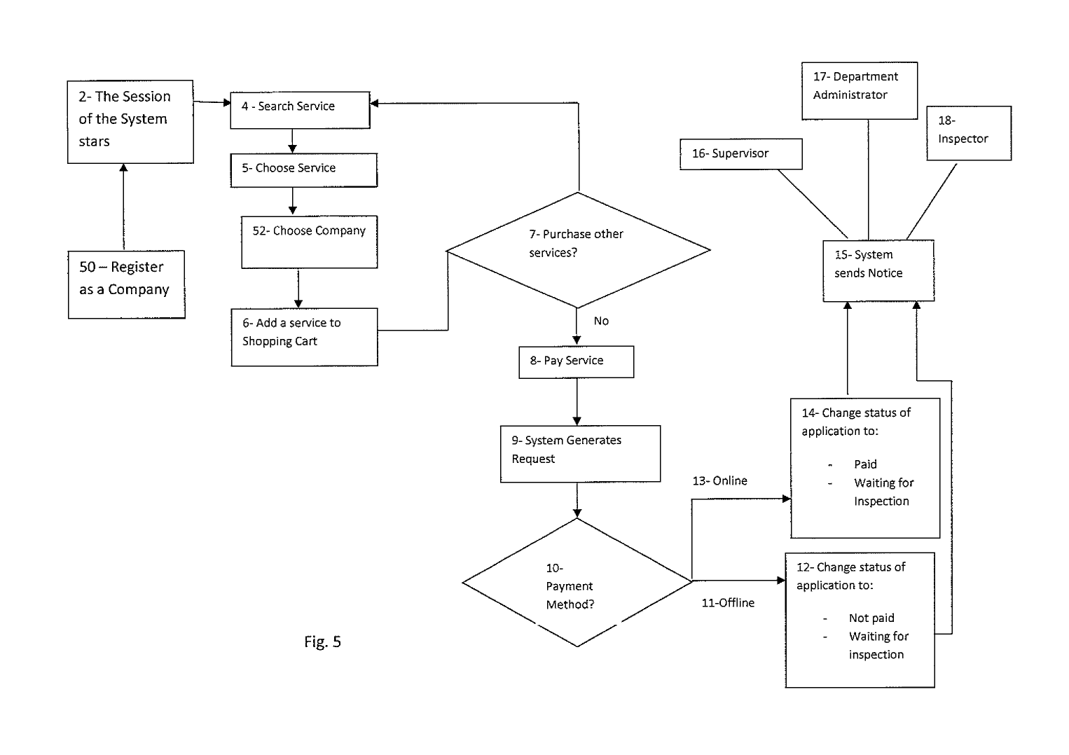

FIG. 4 and FIG. 5 are exemplary block illustrations of the operating the system for clients or customer, wherein said customer include individuals and/or companies using the internet-based interactive computer base platform.

### Clients Modules:

1. A client can register as a person or company in the system by entering personal information or business details from its legal representative.
2. A customer may request various services. This system will generate a pending service and a notification that will be sent to supervisors and inspectors of the permitting agency via email.
3. Then the customer can pay the amount that corresponds to the service, using credit card, or in person through a payment coupon generated in system. All these transactions have a deposit of security.
4. In anytime a client may revise in his module of applications, the status, inspection date, renewal date, etc.
5. When an application needs to be renewed, the system will send via email a notification within a predetermined time period, such as 30 days, in advance.
6. If a customer wishes the renewal of a service will simply click on “Pay” button that will take you to a graphical unit interface to make payment.
7. Client may request technical assistance when needed; communicating via email or phone with the assigned inspector.

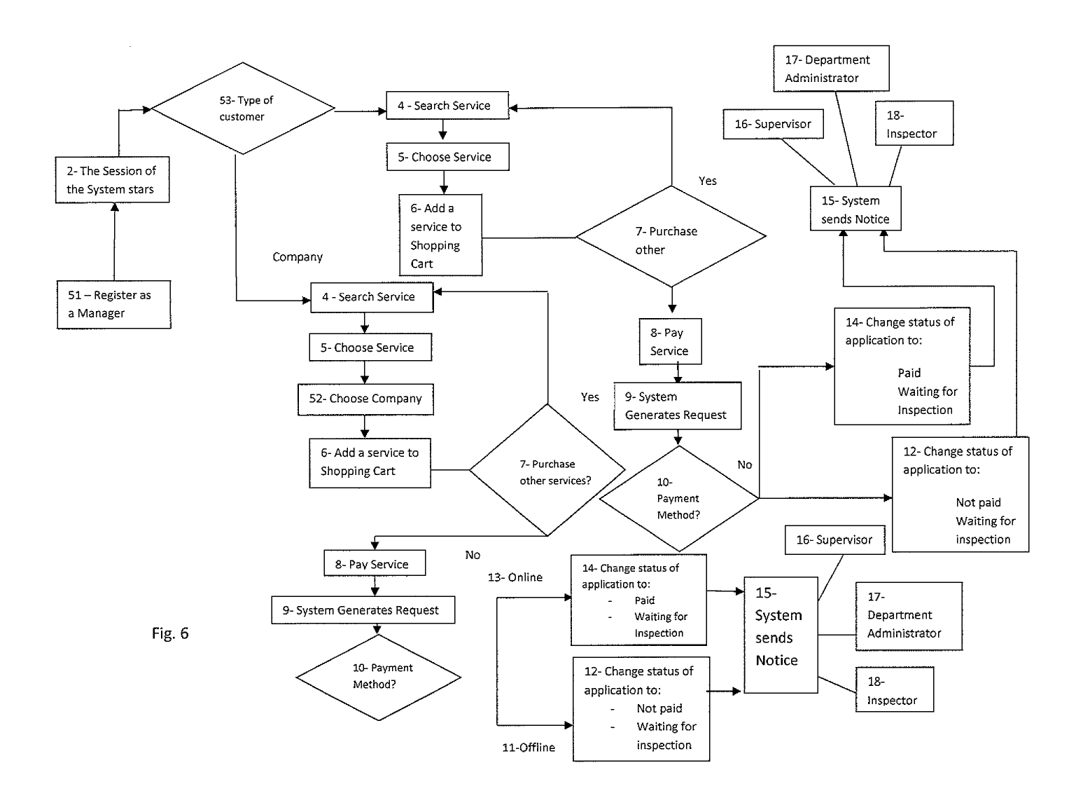

FIG. 6 is an exemplary block illustrations of the operating the system for managers, wherein said manager include individuals and/or companies using the internet-based interactive computer base platform.

### Managers Module:

1. A client (person or company) can apply to a system user (user type manager) to be a manager.
2. The Manager may accept or reject the request.
3. If the manager accepts the application, the user can make the purchase and renovation of its customer services.
4. A customer may remove the manager at anytime.

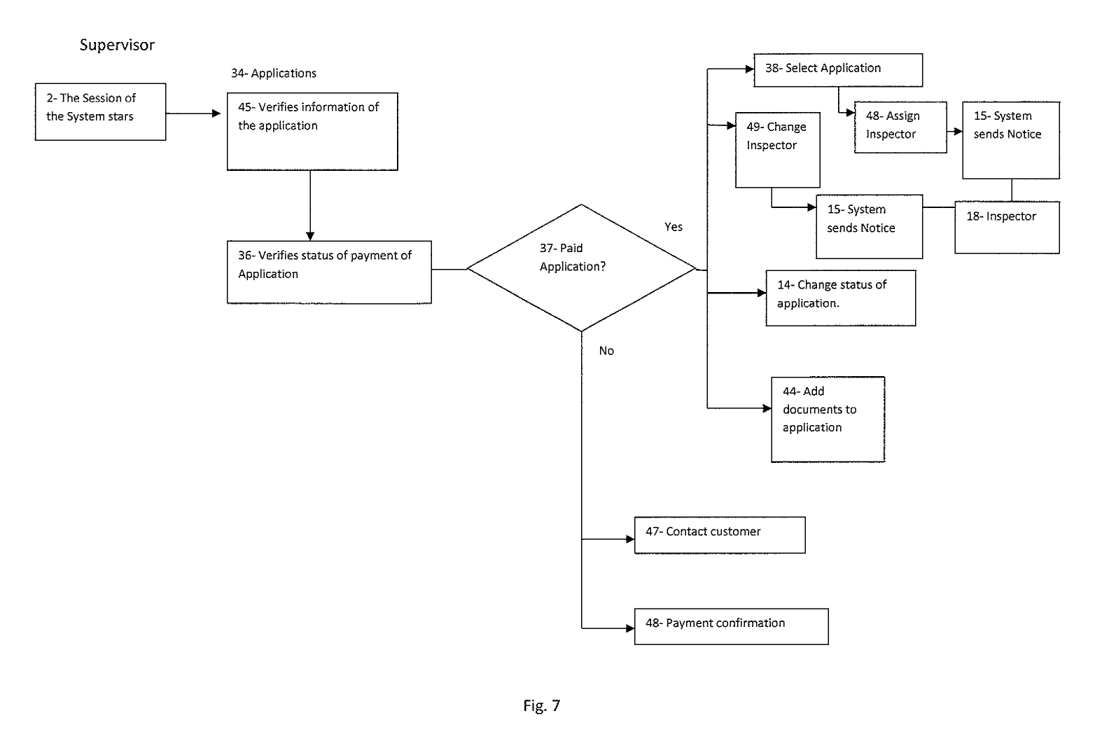

FIG. 7 is an exemplary block illustrations of the operating the system for supervisors, wherein said supervisor of a permitting agency manages applications and assigned application to inspectors using the internet-based interactive computer base platform.

### Supervisors Module:

1. The supervisor of a permitting agency may review pending applications from Online Renewals, either through notices received by email or from the system.
2. The supervisor will have access to a module where one or more applications can be managed and assigned to an inspector.
3. Once the supervisor assigns an inspector to a request, the inspector will receive a notice by email.
4. The supervisor will access to a reports module, where can view the status of client requests.

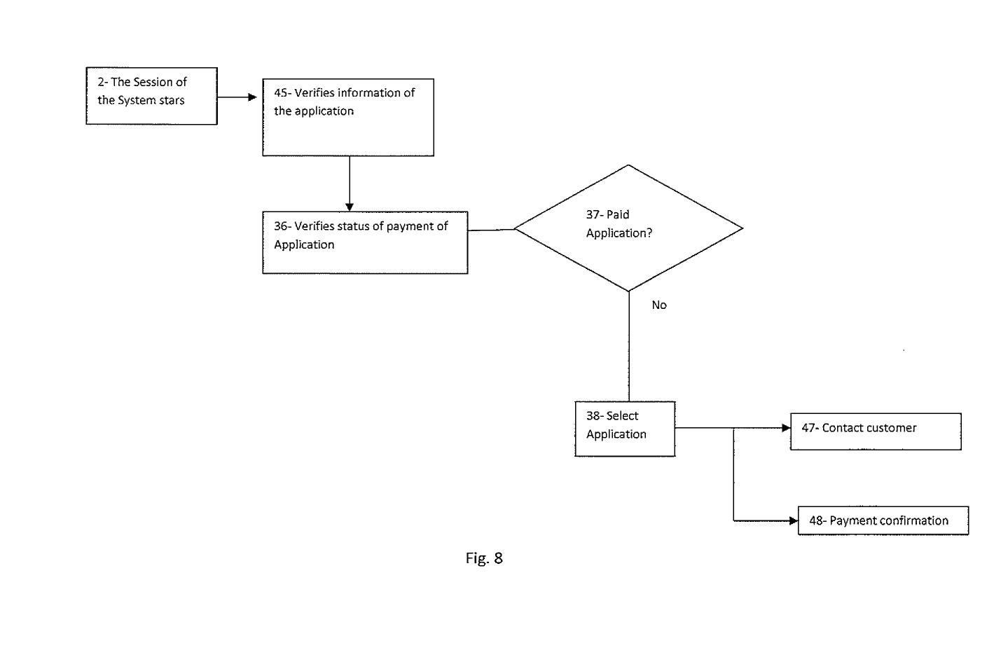

FIG. 8 is an exemplary block illustrations of the operating the system for supervisor of finance, wherein said of finance from a permitting agency manages payments using the internet-based interactive computer base platform.

### Supervisors of Finance Module:

1. Supervisor of Finance Department can review pending requests for payment from the Renewals Online either through notices received by email or from the system.
2. Supervisor will have access to a Reports module, where can be viewed the revenues that have been generated in different periods of time, as well as access to generated invoices.

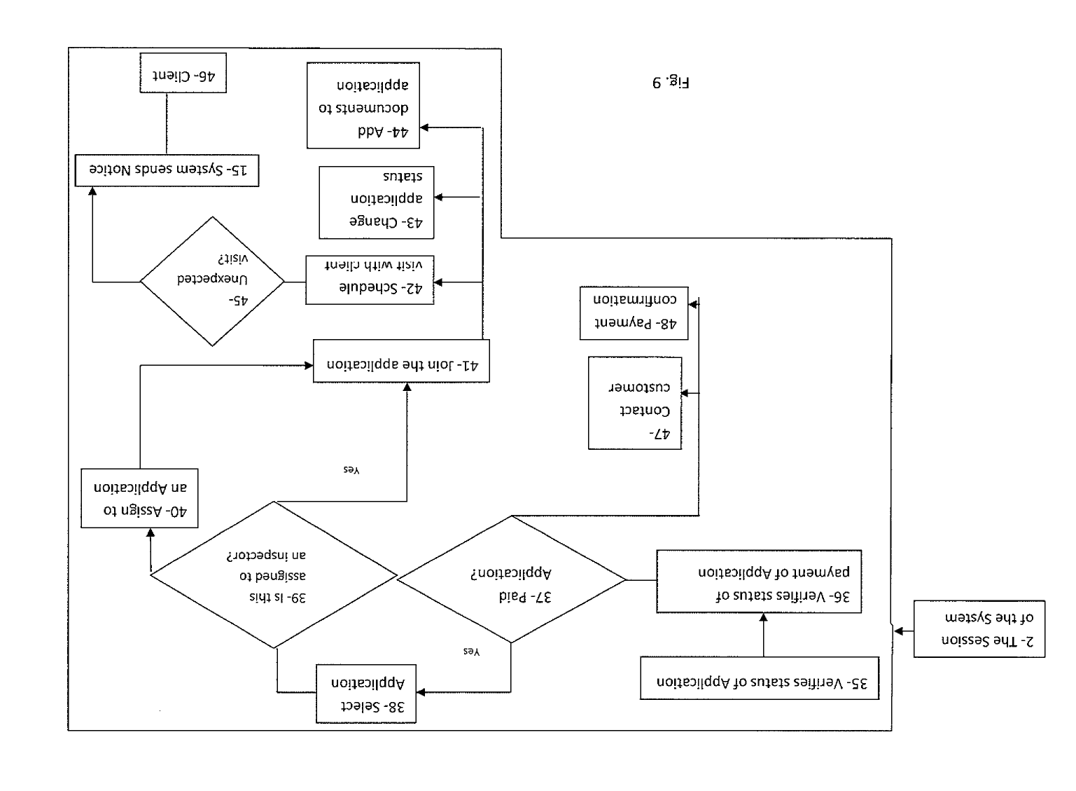

FIG. 9 is an exemplary block illustrations of the operating the system for the inspector, wherein said of inspector from a permitting agency review applications assigned by the supervisor and provide reports to supervisors using the internet-based interactive computer base platform.

### Inspectors Module:

1. The inspector can review which applications were assigned when logged in, so the inspector should communicate with the customer either via email or phone.
2. From the computer platform the inspector can download the sheet to the corresponding inspection requested service, which can print and take-out to the customer residence, to fill in the appropriate data.
3. In the view field, the inspector will fill data sheet inspection and then scan it, upload to the system, so there is evidence of the inspection. Then, this document will be associated with the application in the system, so it can be accessed at any time by him or her supervisors.
4. Depending on the results of the inspection, the application of service requested will be accepted or rejected by the authority agency.
5. If accepted or not, the result will be entered into the system, a fact that can display the Customer,

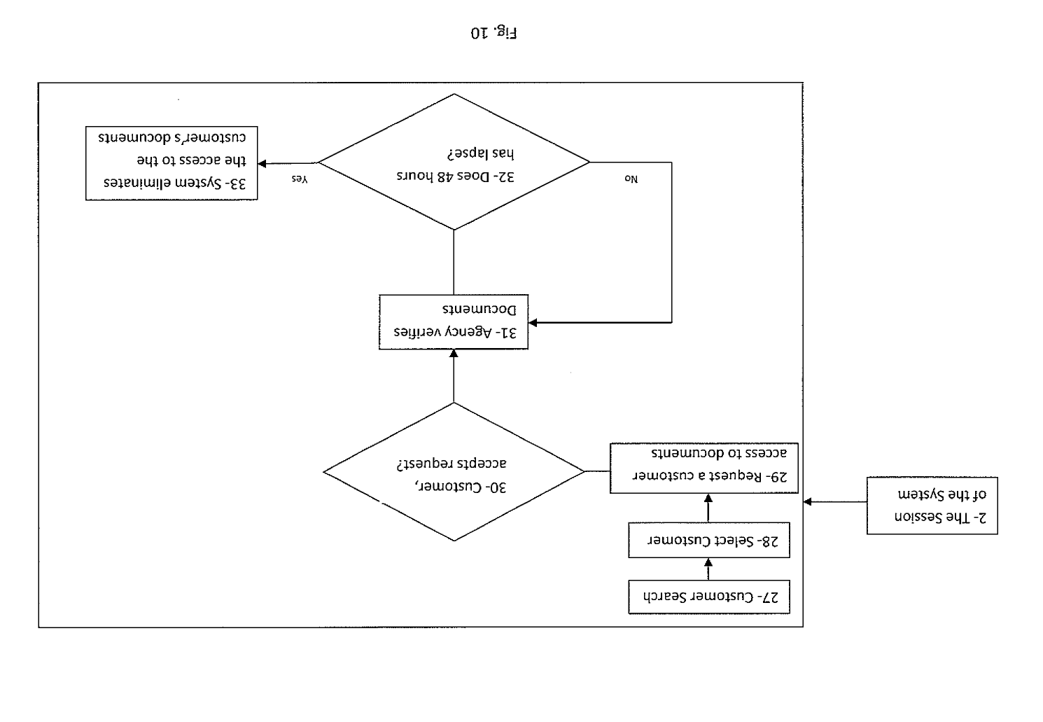

FIG. 10 is an exemplary block illustrations of the operating the system for the permitting agency, wherein said permitting agency review applications, customers information, supervisor, finance's supervisor and inspectors using the internet-based interactive computer base platform.

### Agencies Module:

1. There will be a special module called Agencies. These may access the system to review certain documents of a particular client.
2. Permitting agency may apply for access to certain documents of a customer via email.
3. Once the client gives access to the documents to the system, will add in the module Customers of the Agency, the list of documents requested by a certain time, example 48 hours.
4. Access to documents of a Customer, will only be sent to the Agency representative (registered Renewals Online), thus, no external user will have knowledge of the mechanism to access the documents,
5. For safety in the system, all access to the Documents module of a Customer record, will include: Username of the Agency accessing, Date, Time and IP.

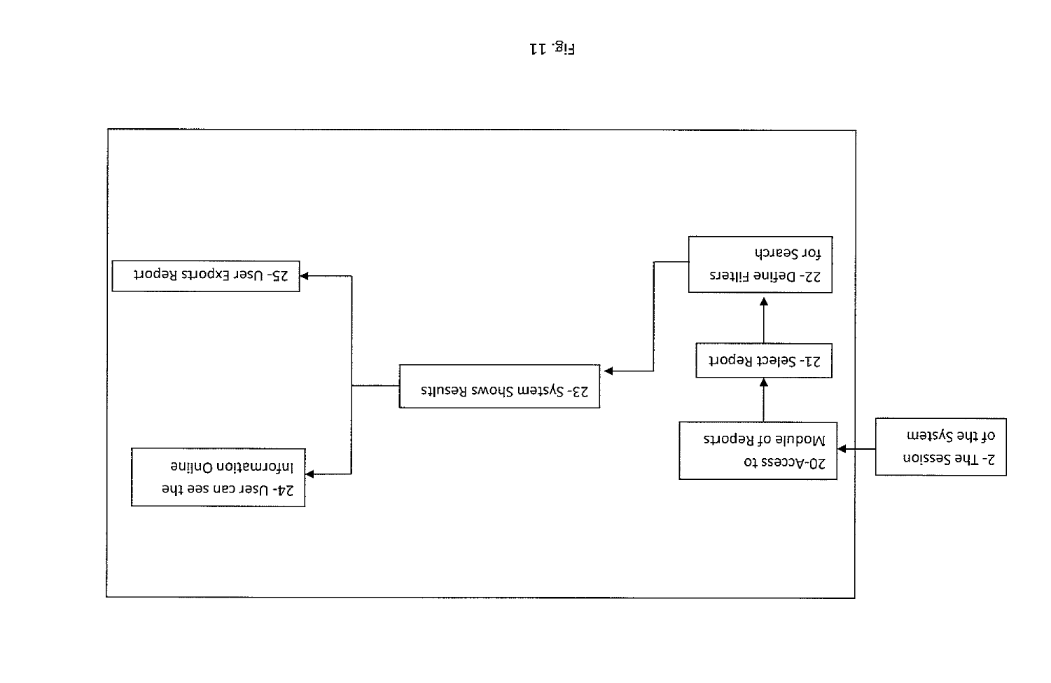

The computer base platform will provide access to a reporting module for certain users. FIG. 11 is an exemplary block illustrations of the operating the system for the user acceding the reports module. By accessing the reports module, users can view the information online or export it to an Excel file, in order to handle data freely. Users can access the Reports module are:
Department Manager
Supervisor of Finance
Supervisor
Inspector

The main reports will relate to requests for services and clients that stores the system. Users may generate reports using different filters, that provides Renewals Online system, such as:
By period: monthly, semi-annual
Services
Payment Status
Request Status
Customers

It will be apparent to those skilled in the art that various modifications and variations can be made to the method and system described in the present disclosure. Other embodiments of the method and system will be apparent to those skilled in the art upon consideration of the specification and practice of the method and system disclosed herein. It is intended that the specification and examples be considered as exemplary only, with a true scope of the disclosure being indicated by the following claims.

1. A method for requesting and renewing permits from a permitting agency using a computer-implemented interactive system, the method comprising:
a permitting agency including an internet-based interactive computer base platform;
a first communication device wherein a first client connect to said internet-based interactive computer base platform;
said permitting agency comprising at least a first manager, at least a supervisor and at least an inspector;
said first client generating a first request for a permit through said internet-based interactive computer base platform;
said supervisor receiving said first request and assigning a inspector;
said inspector evaluating said request and generating a first document;
said document send to said supervisor using said internet-based interactive computer base platform;
approving said permit; and
provide notification to client.
